(19) United States
(12) Patent Application Publication
(10) Pub. No.: US 2024/0300269 A1
(43) Pub. Date: Sep. 12, 2024

(54) TUBELESS TYRE INSERT

(71) Applicant: Alex TRIMNELL, Poole Dorset (GB)

(72) Inventor: Alex TRIMNELL, Pool Dorset (GB)

(21) Appl. No.: 18/258,519

(22) PCT Filed: Dec. 21, 2021
(86) PCT No.: PCT/GB2021/053393

§ 371 Date: Jun. 20, 2023

(30) Foreign Application Priority Data
Dec. 21, 2020 (GB) 2020286.7

(51) Int. Cl. B60C 17/06; B60C 5/00

(52) U.S. Cl. CPC B60C 17/065; B60C 5/002; B60C 2200/04; B60C 2200/10; B60C 2200/12

(57) ABSTRACT

This invention relates to a tyre insert comprising an inner component comprising a first foam material, and an outer component comprising a second foam material, wherein the second foam material has either a higher or lower density than the first foam material, and wherein the outer component comprises an inwardly facing channel which is shaped to accept the inner component. This invention also relates to a wheel for a vehicle comprising a tyre insert as described above, as well as to a vehicle comprising the wheel.

This invention relates to a tyre insert for use in a tubeless tyre for a vehicle, as well as to a wheel for a vehicle, the wheel comprising the tyre insert.

### BACKGROUND

Tyres for motor-driven (e.g. cars, motorcycles, scooters, trucks, planes) or self-propelled vehicles (e.g. bicycles) generally comprise an annular component that surrounds a rim on the wheel of the vehicle. The annular component commonly comprises an outer body usually formed from rubber and which contacts the surface along which the vehicle is to travel. In pneumatic tyres, this outer body encloses an inflatable inner tube which surrounds and is attached to the rim. The inner tube thereby provides cushioning when the vehicle is travelling along uneven surfaces, improving the ride quality for the rider/driver/passenger.

A problem with pneumatic tyres is that the inner tube can often become damaged, particularly when they are used on uneven surfaces, resulting in the inner tube deflating (e.g. a flat tyre).

One attempt at addressing this drawback with pneumatic tyres has been the development of tubeless tyres. Tubeless tyres have the same general structure as a pneumatic tyre, but without the inner tube. Instead, the outer body of the tyre is manufactured or treated such that it creates a substantially airtight seal between the outer body and the rim of the wheel. For example, a sealant may be applied to the inner surface of the outer body of the tyre.

A further development in the field of tubeless tyres has been the used of annular foam tyre inserts. These inserts can provide several improvements including (i) protection against damage to the wheel rim by absorbing some of the impact when the tyre travels over rough terrain, (ii) reduction in pinch punctures, (iii) increased rigidity of the sidewalls of the tyre, (iv) an additional damping effect to the tyre, and (v) better attachment of the tyre to the wheel rim. Tubeless tyre inserts can also allow the use of lower tyre pressures.

There are three main types of tubeless tyre insert. The first is known as the “flat” insert, such as those sold by Huck Norris. These annular inserts have a generally rectangular cross-section, with the opposing longer sides of the rectangle facing the wheel rim and the surface-contacting side of the tyre respectively, and the shorter sides facing the sidewalls of the tyre. Such “flat” inserts are usually a less expensive option, and often do not provide an improvement in the rigidity of the sidewalls of the tyre.

The second main category of tubeless tyre inserts is “tube” inserts, such as the Flat Tire Defender. These annular inserts have a generally circular cross-section. Such inserts can provide improved rim protection, a reduction in impact punctures, and improved rigidity of the sidewalls of the tyre. “Tube” inserts can be difficult to fit to the wheel rim. In addition, they can block the flow of sealant in the tyre, meaning that the benefits of the sealant may not be maximised.

The third main category of tubeless tyre inserts is “hybrid” inserts, such as the Cushcore Pro. These inserts attempt to combine the benefits of “flat” and “tube” inserts. The annular inserts have a v-shaped or triangular cross-section, with the point of the “v” (or a point of the triangle) abutting the wheel rim, and the other two points extending towards the sidewalls of the tyre. “Hybrid” inserts can also be difficult to fit to the wheel rim, and can block the inflation valve of the tyre.

A further development has been the design of multiple layer foam inserts by Air Fom.

Improvements in tubeless tyre inserts have been sought.

### STATEMENT OF INVENTION

This invention relates to a tyre insert comprising an inner component comprising a first foam material, and an outer component comprising a second foam material, wherein the second foam material has either a higher or lower density than the first foam material, and wherein the outer component comprises an inwardly facing channel which is shaped to accept the inner component. The density of the second foam material can be selected by the user to be either higher or lower than the first foam material depending on the terrain upon which the tyre insert is to be used.

In the context of the invention, the term “inner” is used to refer to the part of the tyre insert that, in use, is closest to the rim of the wheel to which it is attached. Similarly, the term “outer” is used to refer to the part of the tyre insert that, in use, is closest to the surface-contacting part of the tyre (and furthest from the rim of the wheel).

In particular, the first foam material may comprise a closed cell foam, even more particularly a closed cell crosslinked foam. More particularly, the inner component may consist substantially of the first foam material. In particular, the first foam material may comprise a polyolefin foam.

More particularly, the second foam material may comprise a closed cell foam, even more particularly a closed cell crosslinked foam. In particular, the outer component may consist substantially of the second foam material. In particular, the second foam material may comprise a polyolefin foam.

In particular, the tyre insert may be annular. More particularly, the inner component and the outer component may be annular. In particular, the inwardly facing channel of outer component may be formed by an outer base and two arms which extend inwardly from the outer base. Even more particularly, the two arms may extend inwardly and towards each other from the outer base. For example, the outer component may substantially be u-shaped, with the base of the u-shape corresponding to the outer base, and the two sides of the u-shape corresponding to the two arms of the outer base. In particular, the two arms of the outer base may form an inwardly facing opening.

More particularly, the inner component may have a shape which substantially corresponds to that of the inwardly facing channel of the outer component. Even more particularly, the inner component may comprise a head which is shaped to fit into the inwardly facing channel of the outer component and a two legs which extend inwardly from the head. In particular, the two legs may extend inwardly such that they protrude from the inwardly facing opening.

When fitting the tyre insert to rim of a wheel, the two legs allow ease of fitting by deflecting over an outer lip of the rim. The inner ends of each leg allow the tyre insert to seat on the rim, preferably the centre of the rim, of the wheel in use. In particular, the two legs may be shaped such that, in use, there is an annular void formed which is bounded by each leg and the head of the inner component, and the rim of the wheel to which the tyre insert is fitted. The annular void can assist in allowing air and sealant flow around the tyre insert during use.

In particular, the tyre insert may comprise one or more channels extending radially from an inner side of the tyre insert to an outer side of the tyre insert. More particularly, the tyre insert may be provided with five or more channels, even more particularly ten or more channels, extending radially from an inner side of the tyre insert to an outer side of the tyre insert. In particular, the channels may have a substantially circular, triangular, rectangular, square, oval, diamond, pentagonal, hexagonal or octagonal cross-section. More particularly, the channels may have a substantially circular cross-section. In particular, the channels may taper from an inner end towards an outer end. The channels can assist in allowing air and sealant flow around the tyre insert during use.

More particularly, the tyre insert may be for a vehicle tyre. In particular vehicle may be a bicycle, electric bicycle, motorcycle, electric motorcycle, scooter, car, lorry, truck or plane. More particularly, the bicycle may be a mountain bike.

The invention also relates to a wheel for a vehicle comprising a tyre insert as described above. More particularly, the wheel may comprise a rim having an inner circumference and an outer circumference, a tyre mounted around the outer circumference of the rim; and the tyre insert inside the tyre. In particular, the wheel rim may comprise an aperture for accepting an inflation valve. More particularly, the wheel rim may optionally comprise an aperture for accepting a rim lock. In particular, the rim lock may have first and second ends, the first end comprising a rim lock head which is shaped to be accepted by one of the channels in the tyre insert. In this way, rotation of the tyre insert relative to the wheel rim can be limited or substantially prevented. In particular, the wheel may be for a vehicle as described above.

In addition, the invention relates to a vehicle comprising one or more wheels as described above. The vehicle may be as described above.

### BRIEF DESCRIPTION OF THE DRAWINGS

This invention will be further described by reference to the following FIGS. which are not intended to limit the scope of the invention claimed, in which:

FIG. 1 shows a perspective view of a tyre insert of the invention,

FIG. 2 shows an end-on view of the tyre insert of FIG. 1,

FIG. 3 shows a perspective view of the tyre insert of FIG. 1 when fitted to a wheel rim,

FIG. 4 shows cross-sectional views of the inner (left) and outer (right) components of the tyre insert of FIG. 3,

FIG. 5 shows a cross-sectional view of the tyre insert of FIG. 3, i.e. when fitted to a wheel rim, and

FIG. 6 shows a cross-sectional view of the tyre insert of FIG. 3 through an inflation valve which has been fitted into the tyre insert.

### DETAILED DESCRIPTION

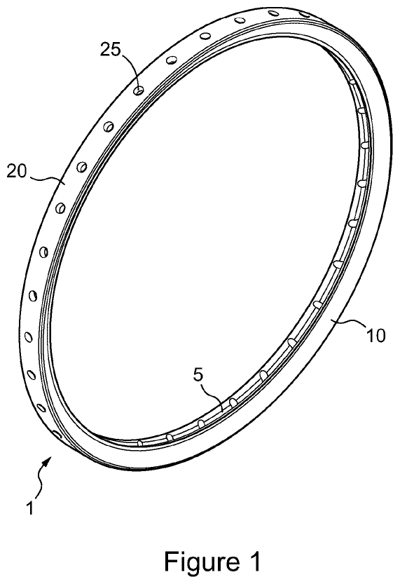

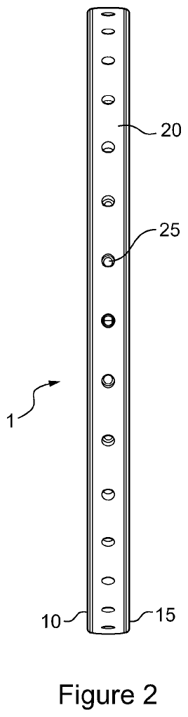

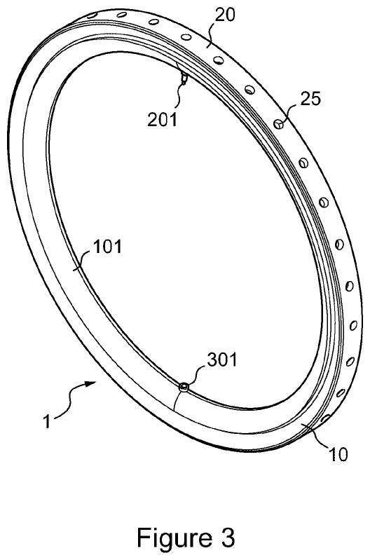

FIGS. 1 and 2 show perspective and end-on views respectively of a tyre insert 1 according to the invention. FIG. 3 shows a perspective view of the tyre insert 1 when fitted to a wheel rim 101.

As shown in FIGS. 1, 2 and 3, the tyre insert 1 is annular in shape and comprises an inner surface 5 (only visible in FIG. 1) and side walls 10 and 15 (only side wall 10 being visible in FIGS. 1 and 3). As shown in FIGS. 1, 2 and 3, the tyre insert also comprises outer surface 20.

Extending from the outer surface 20 to the inner surface 5 are multiple through holes or channels, an example of which is indicated 25 in FIGS. 1, 2 and 3. The through holes 25 have a circular cross-section.

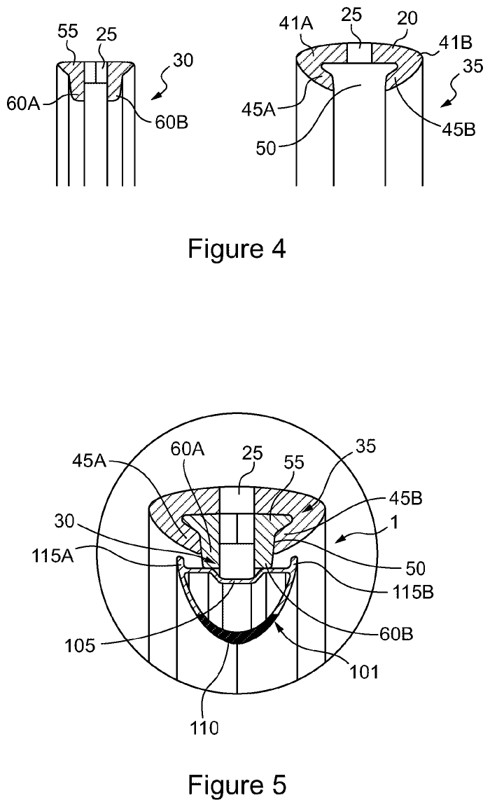

The tyre insert 1 comprises two annular component parts, and inner component 30 and an outer component 35. These are shown in cross-section, separated from one another, in FIG. 4. The left-hand side of FIG. 4 shows inner component 30, and the right-hand side shows outer component 35.

Outer component 35 is approximately u-shaped, and comprises an outer surface 20 which faces the surface-contacting part of the tyre (not shown) and two arms 45A, 45B. The arms 45A, 45B extend from the two annular edges 41A, 41B of outer surface 20. The arms 45A, 45B extend inwardly and towards each other such that they form jaws of annular inner channel 50 of outer component 35.

Inner component 30 has a shape substantially corresponding to that annular inner channel 50 of outer component 35. Inner component 30 comprises a head 55 which fits into annular inner channel 50 and two legs 60A, 60B which extend inwardly from the head 55. The inner ends of legs 60A, 60B thereby form inner surface 5 of tyre insert 1. Both inner component 30 and outer component 35 are shown in cross-section through one of the through holes 25.

The inner component 30 is formed from a first foam material. The outer component 35 is formed from a second foam material. Both the first and second foam materials are closed cell foams. The inner component 30 is formed from a polyolefin foam 12. The outer component 35 is formed from a polyolefin foam. In some embodiments, the first foam material can have a higher density than the second foam material. In other embodiments, the first foam material can have a lower density than the second foam material.

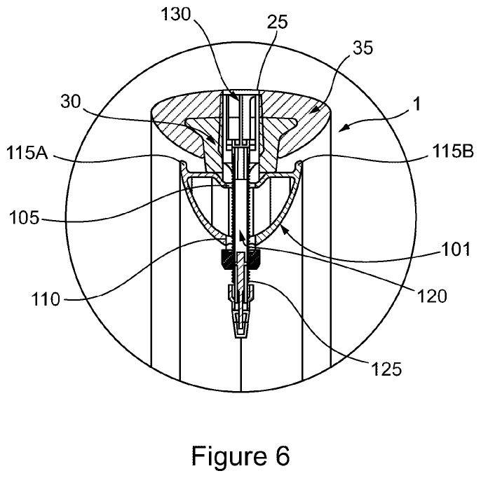

FIGS. 5 and 6 show the inner 30 and outer 35 components that form tyre insert 1 when fitted together and around wheel rim 101. All of the component parts from FIG. 4 are present in FIGS. 5 and 6, but for ease of reference not all are labelled. As shown in FIGS. 5 and 6, the cross-section of wheel rim 101 is substantially in the form of an upside down letter “A”, although other wheel rim shapes could be used.

In order to fit the inner component 30 into the outer component 35, the head 55 of the inner component 30 is pushed into annular inner channel 50 of outer component 35. The arms 45A, 45B of the outer component 35 deflect around the head 55 such that it is accepted into channel 50. The legs 60A, 60B then extend inwardly from the channel 50.

The assembled tyre insert 1 is then fitted to the wheel rim 101 as shown in FIGS. 5 and 6. The tyre insert 1 is pushed onto the rim and the legs 60A, 60B deflect in order to allow the tyre insert 1 to fit into the outer channel 110 of wheel rim 101 which is formed by the two legs 115A, 115B of the “A”.

FIGS. 5 and 6 show a cross-section through one of the through holes 25. FIG. 6 shows a inflation valve assembly 120 fitted through a corresponding hole 125 of the wheel rim 101. The inflation valve assembly comprises a valve body 125 which is adapted for connection to an inflation device, and a valve head 130 which is shaped to be accepted by the through hole 25.

A circular hole (not visible in FIG. 5) is provided in both horizontal bar 105 and at peak 110 of the “A”. Inflation valve assembly 120 has been inserted inwardly through the holes such that it is seated on bar 105.

Also shown in FIG. 3 is rim lock 301 fitted through wheel rim 101 on an opposite face to inflation valve 201. Rim lock 301 is an optional feature, but is present in the embodiment in the Figures. Although not shown in FIG. 3, rim lock 301 is fitted through tyre insert 1 and into one of the circular channels 25. Rim lock 301 has a similar shape to inflation valve 201, but does not include a valve. In this way, rotation of the tyre insert 1 relative to the wheel rim 101 can be substantially prevented.

1. A tyre insert comprising an inner component comprising a first foam material, and an outer component comprising a second foam material, wherein the second foam material has either a higher or lower density than the first foam material, and wherein the outer component comprises an inwardly facing channel which is shaped to accept the inner component.

2. A tyre insert as claimed in claim 1, wherein the first foam material comprises a closed cell foam.

3. A tyre insert as claimed in claim 2, wherein the first foam material comprises a polyolefin foam.

4. A tyre insert as claimed in claim 1, wherein the second foam material comprises a closed cell foam.

5. A tyre insert as claimed in claim 4, wherein the second foam material comprises a polyolefin foam.

6. A tyre insert as claimed in claim 1, wherein the inwardly facing channel of the outer component is formed by an outer base and two arms which extend inwardly from the outer base.

7. A tyre insert as claimed in claim 6, wherein the two arms extend inwardly and towards each other from the outer base.

8. A tyre insert as claimed in claim 1, wherein the inner component has a shape which substantially corresponds to that of the inwardly facing channel of the outer component.

9. A tyre insert as claimed in claim 1, wherein the inner component comprises a head which is shaped to fit into the inwardly facing channel of the outer component and a two legs which extend inwardly from the head.

10. A tyre insert as claimed in claim 9, wherein the two legs are shaped such that, in use, there is an annular void formed which is bounded by each leg and the head of the inner component, and a rim of a wheel to which the tyre insert is fitted.

11. A tyre insert as claimed in claim 1, comprising one or more channels extending radially from an inner side of the tyre insert to an outer side of the tyre insert.

12. A wheel for a vehicle comprising a tyre insert comprising an inner component comprising a first foam material, and an outer component comprising a second foam material, wherein the second foam material has either a higher or lower density than the first foam material, and wherein the outer component comprises an inwardly facing channel which is shaped to accept the inner component.

13. A wheel for a vehicle as claimed in claim 12, wherein the wheel comprises a rim having an inner circumference and an outer circumference, a tyre mounted around the outer circumference of the rim; and the tyre insert of any one of claims 1-11 inside the tyre.

14. A wheel for a vehicle as claimed in claim 12, wherein the vehicle is a bicycle, electric bicycle, motorcycle, electric motorcycle, scooter, car, lorry, truck or plane.

15. A vehicle comprising a wheel comprising a tyre insert comprising an inner component comprising a first foam material, and an outer component comprising a second foam material, wherein the second foam material has either a higher or lower density than the first foam material, and wherein the outer component comprises an inwardly facing channel which is shaped to accept the inner component.
